(19) United States
(12) Patent Application Publication
(10) Pub. No.: US 2006/0202975 A1
(43) Pub. Date: Sep. 14, 2006

(54) Light guiding apparatus for optical pen

(75) Inventor: Shui Chuan Chiang, Hsinchu City (TW)

Correspondence Address: TROXELL LAW OFFICE PLLC, 5205 LEESBURG PIKE, SUITE 1404, FALLS CHURCH, VA, 22041, US

(73) Assignee: AIPTEK INTERNATIONAL INC.

(21) Appl. No.: 11/115,114

(22) Filed: Apr. 27, 2005

(30) Foreign Application Priority Data
Mar. 11, 2005 (TW) 094107416

(51) Int. Cl. G09G 5/00

(52) U.S. Cl. 345/179

(57) ABSTRACT

A light guiding apparatus for optical pen comprising a light source, an optical sensor and a light guide is disclosed. The light source emits light towards an outlying surface where the optical sensor captures a reflected imaging light that travels in a direction defined with a captured light. The light guide is made of light conducting material and consists of a light-inlet, an extension member, and a light-outlet. The light-inlet is disposed near the light source. The extension member extends a predetermined distance from the light-inlet essentially along a direction parallel and opposite to the captured light. The light-outlet is situated at an end of extension member farther away from the light-inlet. The light emitted by the light source is first guided by the light guide and then illuminates on the outlying surface at an inclined angle ranged between 21˜50 degrees to enhance the contrast and recognizability of reflected imaging light.

### BACKGROUND OF INVENTION

1. Field of the Invention

The present invention relates to a light guiding apparatus for optical pen, in particular a kind of optical pen that integrates the functions of optical mouse and handwriting recognition and obtains better image recognition through a light guiding apparatus that guides the light to shine on an outlying surface at a predefined angle.

2. Description of the Prior Art

For electronic information devices such as desktop or notebook computers, personal digital assistants (PDA), and smart phones that require massive data input, handwriting input device is undoubtedly a convenient alternative to mouse and keyboard.

Currently known handwriting input devices may be categorized into three types; one needs to be used with pressure-sensing touch screen, one uses electromagnetic-sensing digital panel, and one uses optical pen. Optical pen is the more popular handwriting input device at the present time due to its relatively low cost and the ability to write on any surface.

FIG. 1 is a schematic view of conventional optical pen 10, which is essentially an optical mouse in the shape of a pen. The shaft of the pen 11 makes it easy for the users to hold the pen when writing, while light source 12 and optical sensor 13 arranged at the bottom of the body 11 can capture the reflected image in a small area 16 on an outlying surface 15 near the tip of the pen 14. When the optical pen 10 moves, the captured images will undergo continuous and directional changes, from which the moving directions and speed of optical pen 10 are detected. By transmitting such information to an electronic information device connected to the optical pen 10 for processing, handwriting input is achieved.

However conventional optical pen 10 as shown in FIG. 1 has an apparent drawback. Constrained by the slimness of tip 14, the light source 12 of optical pen 10 cannot be configured directly near tip 14, but rather in the body 11 of the pen at a certain distance away from the outlying surface 15. Consequently, the angle θ1 intersecting the light emitted from light source 12 and outlying surface 15 is typically greater than 70 degrees. When the user habitually holds the optical pen 10 vertically during writing, the value of θ1 even approximates 90 degrees. Under the direct illumination of light source 12 at a large angle, the contrast ratio of imaging light reflected from outlying surface 15 will be lowered, resulting in poor signal detection by optical sensor 13 and hence increasing the difficulty and error in image recognition. That is why conventional optical pens 10 on the market must be used together with a pad or a work surface printed with special pattern to boost the success rate of image recognition, which nevertheless restricts the movement and convenience of optical pen 10.

U.S. Pat. No. 6,433,780 discloses an optical mouse that achieves the objective of shedding light from the light source onto an outlying surface at an inclined angle by obliquely arranging the light source at the side proximate to the outlying surface and at a considerable distance from the photo detector. However, the optical mouse disclosed in U.S. Pat. No. 6,433,780 has relatively large dimensions that allow the light source to be disposed obliquely at a location with considerable distance from the photo detector. In the technical field of optical pen 10 to which the present invention applies, the body of the pen 10 is always in long, slender shape. The light source 12 and optical sensor 13 arranged at the bottom of the body 11 are closely arranged right next to each other that makes it impossible for the light source 12 and optical sensor 13 to be neither arranged near the pen tip nor close to the outlying surface 15. Essentially it is unlikely for conventional optical pen 10 to have the light source arranged obliquely and at a certain distance from the photo detector as shown in the device disclosed in U.S. Pat. No. 6,433,780. That means the art disclosed in U.S. Pat. No. 6,433,780 cannot be applied directly to optical pen 10.

### SUMMARY OF INVENTION

The primary object of the present invention is to provide a light guiding apparatus for optical pen that can obtain better reflected image light through the arrangement of a light guide that guides the light from light source to shine on an outlying surface at a predefined inclined angle.

To achieve the aforesaid object, a light guiding apparatus for optical pen according to the present invention comprises a light source, an optical sensor and a light guide. The light source emits light rays towards an outlying surface where the optical sensor captures a reflected imaging light therefrom that travels in a direction defined with a captured light. The light guide is made of light conducting material and consists of a light-inlet, an extension member, and a light-outlet. The light-inlet is disposed near the light source. The extension member extends a predetermined distance from the light-inlet essentially along a direction parallel and opposite to the direction of captured light. The light-outlet is situated at an end of extension member away from the light-inlet. The light emitted by the light source is first guided by the light guide and then illuminates on the outlying surface at an inclined angle of less than 50 degrees to enhance the contrast and recognizability of reflected imaging light.

Preferably the angle intersecting the rays from light guide and outlying surface is ranged between 21˜50 degrees, and more preferably between 25˜40 degrees to obtain even better image recognition effect.

Preferably the area of a cross section of the extension member of light guide tapers gradually in a direction from the light-inlet towards the light-outlet.

Preferably the portion of light guide farther away from the light source is disposed with an excised part to give light guide a shape similar to the nib construction of regular fountain pen.

Preferably the exterior of light guide is further disposed with a wear-resistant cap to protect the end of light guide. In addition, the wear-resistant cap is configured with an opening at a position corresponding to the light-outlet.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

The details of the present invention will be more readily understood from a detailed description of the preferred embodiments taken in conjunction with the following figures.

FIG. 1 is a schematic view of a conventional optical pen.

FIG. 2 is a schematic view of the first preferred embodiment of a light guiding apparatus of optical pen according to the invention.

FIG. 3 is a schematic view of the second preferred embodiment of a light guiding apparatus of optical pen according to the invention.

FIG. 4 is a schematic view of the third preferred embodiment of a light guiding apparatus of optical pen according to the invention.

FIG. 5 is a schematic view of the fourth preferred embodiment of a light guiding apparatus of optical pen according to the invention.

FIG. 6 is a schematic view of the fifth preferred embodiment of a light guiding apparatus of optical pen according to the invention.

FIG. 7A is a perspective view of the sixth preferred embodiment of a light guiding apparatus of optical pen according to the invention.

FIG. 7B is a cross sectional view of the sixth preferred embodiment of a light guiding apparatus of optical pen according to the invention.

### DETAILED DESCRIPTION

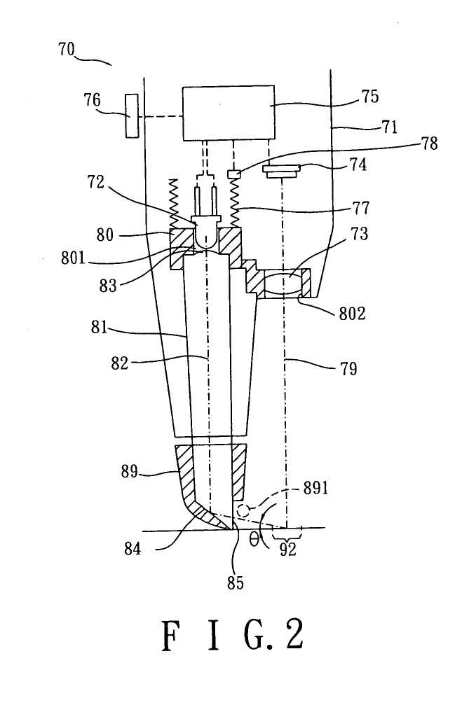

Referring to FIG. 2 which shows a schematic view of the first preferred embodiment of a light guiding apparatus of optical pen 70. The optical pen 70 according to the present invention comprises a shaft 71, a light source 72, a lens 73, an optical sensor 74, a control unit 75, a button 76, an elastic member 77, a pressure sensor 78, and a light guiding apparatus. In this embodiment, the light guiding apparatus consists of a positioning frame 80 and a light guide 81. The positioning frame 80 is disposed with positioning holes 801 and 802 of predefined shape for accommodating and positioning light source 72, light guide 81 and lens 73. Moreover, light guide 81 is situated at an end (bottom) of shaft 71 and constitutes the pen-tip part of optical pen 70.

The shaft 71 constitutes the body of optical pen 70 to accommodate its parts. In this embodiment, shaft 71 is in long and narrow rod shape with predefined length and width generally suitable for holding by hand.

The light source 72 produces light to shine on a predetermined location 92 on an outlying surface 91 near an end (bottom) of shaft 71 to obtain reflected imaging light in a small area of predetermined location 92 on the outlying surface 91. In this embodiment, the light source 72 may be a light-emitting diode (LED) or a micro-sized conventional tungsten light bulb. The reflected imaging light travels in a direction defined with a captured light 79. In this embodiment, the direction of captured light 79 is essentially parallel to the extension of long narrow shaft 71, but does not overlap with it.

The lens 73 is disposed anterior to optical sensor 74, which may be a single lens or a lens set to converge imaging light and form images on optical sensor 74.

Optical sensor 74 is for detecting imaging light from the predetermined location 92 nearby the end (bottom) of shaft 71 and converting it into an electric signal. In this embodiment, the optical sensor 74 is a CMOS sensor or a charge coupled device (CCD) sensor and located in the direction of captured light 79.

The control unit 75 is connected to light source 72 and optical sensor 74 to receive electrical signal from optical sensor 74 and process the signal to generate a corresponding first control signal, which is then transmitted in a wired or wireless fashion to an external electronic information device (not shown in the figure) connected to optical pen 70 for further processing to execute a first predetermined function, such as controlling the movement and positioning of cursor or handwriting input.

The button 76 is connected to the control unit 75. By pressing the button 76, the control unit 75 can produce a corresponding second control signal, which is transmitted to a connecting external electronic information device for further processing to execute a second predetermined function, such as executing the function corresponding to the position of cursor (similar to the function performed by the button of conventional mouse).

The elastic member 77 is furnished between positioning frame 80 and the interior wall of shaft 71. Elastic member 77 provides a recoil force that allows positioning frame 80, together with light source 72, light guide 81 and lens 73, to carry out vertical compressive micro-displacement (0.5˜5 mm) relative to shaft 71. The other end of elastic member 77 is connected to a pressure sensor 78, which detects the pressure change of elastic member 77 resulting from the compressive displacement of positioning frame 80 (along with light source 72, light guide 81 and lens 73) and generates a corresponding third control signal, which is transmitted to control unit 75 for execution of a third predetermined function, such as changing the thickness of graphical or textual lines of handwriting input according to the level of pressure to write, for example, brush strokes.

The exterior of light guide 81 is further disposed with a wear-resistant cap 89 to protect the tip. Given that light guide 81 is made of transparent plastic material, its tip at the very end is prone to wear after prolonged friction with outlying surface 91. So in this embodiment, a wear-resistant cap 89 is mounted on light guide 81, which is designed with an opening 891 near the very end of tip that would allow light rays to reach a predetermined location 92 on the outlying surface 91 at a low angle so optical sensor 74 can detect clear images.

As shown in FIG. 2, the light guide 81 of the present invention is propped by positioning frame 80 and situated at an end (bottom) of shaft 71 to constitute a tip construction of shaft 71. Moreover, light guide 81 has a solid, long and narrow cone-column construction defined with an axial direction 82 of tip for reflected imaging light to pass through. In this embodiment, light guide 81 is made of light conducting material (e.g. transparent plastic, acrylic, glass or quartz) and comprises a light-inlet 83, a reflective plane 84 and a light-outlet 85. The light-inlet 83 is adjacent to light source 72. In this embodiment, the light-inlet 83 has a convex structure to converge scattered light rays from light source 72 such that the light emitted from light source 72 into light guide 81 would essentially travel parallel along the axial direction 82 of tip. The inner diameter of light guide 81 would taper gradually from the light-inlet 83 along the axial direction 82 of tip into a long narrow cone-column shape, which could better converge the rays inside. The reflective plane 84 and the light-outlet 85 are situated at one end (bottom) of light guide 81 farther away from light-inlet 83, and light-outlet 85 is nearby the predetermined location 92 on outlying surface 91.

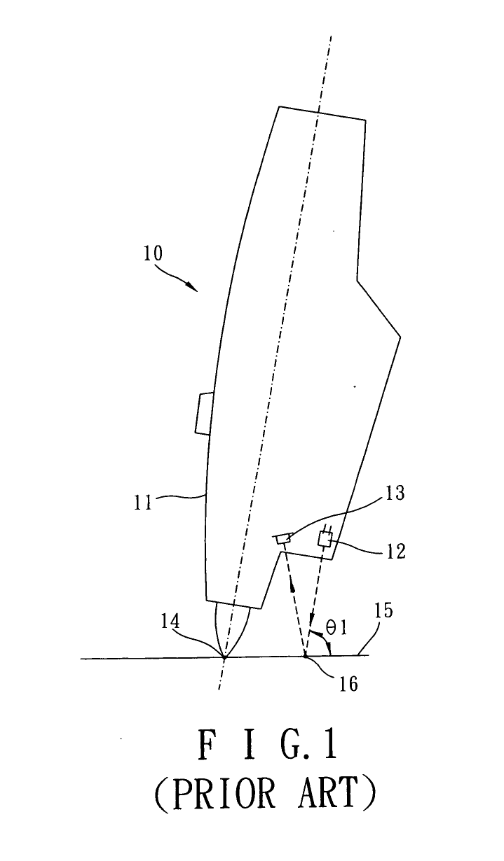

The light conducting material of light guide 81 has a predetermined refraction coefficient that the surface of light guide 81 would reflect light traveling inside it when the angle intersecting the light traveling direction and the surface of light guide 81 is less than a predefined angle, thereby providing the function of light conduction. For example, when this embodiment uses transparent polycarbonate plastic as the material of light guide 81, light undergoes total reflection inside light guide 81 when the angle intersecting the light traveling direction and the surface of light guide 81 is less than 37 degrees. In contrast, when the same angle is greater than 37 degrees, light will penetrate and shine through light guide 81. Based on the light reflection characteristics of the light conducting material, the light guiding apparatus of optical pen according to the present invention is further disposed with a reflective plane 84 at the end of light guide 81 on the side opposing the light-outlet 85. The intersection angle between reflective plane 84 and the axial direction of tip 82 has a predefined degree. Said intersection angle is an acute angle and it can make light rays traveling parallel to the axial direction of tip 82 shoot at the reflective plane 84 at an angle less than 37 degrees. As such, the light rays inside light guide 81 are totally reflected by reflective plane 84 to shoot at light-outlet 85. Further, those light rays reflected by reflective plane 84 would penetrate the surface of light guide 81 and shoot at a predetermined location 92 on the outlying surface 91 given that the angle intersecting the light rays and light-outlet 85 is greater than 37 degrees. In this embodiment, the intersection angle θ between the light rays from the light-outlet 85 of light guide 81 and outlying surface 91 is between 21˜50 degrees. As such, the contrast ratio of the reflected imaging light on outlying surface 91 would increase significantly as compared to prior art as shown in FIG. 1. Consequently, the quality and recognizability of images detected by the optical sensor 74 of optical pen 70 would also rise substantially, even in the absence of a pad printed with special pattern. In addition, based on the results of experiment, the quality and recognizability of images detected by optical sensor 74 can improve further if the aforesaid intersection angle θ ranges between 25˜40 degrees.

In another embodiment of the present invention, the reflective plane 84 of light guide 81 is designed into an arc or spherical structure to obtain better light convergence effect inside light guide 81 and consequently increase the luminosity of light received at the predetermined location 92.

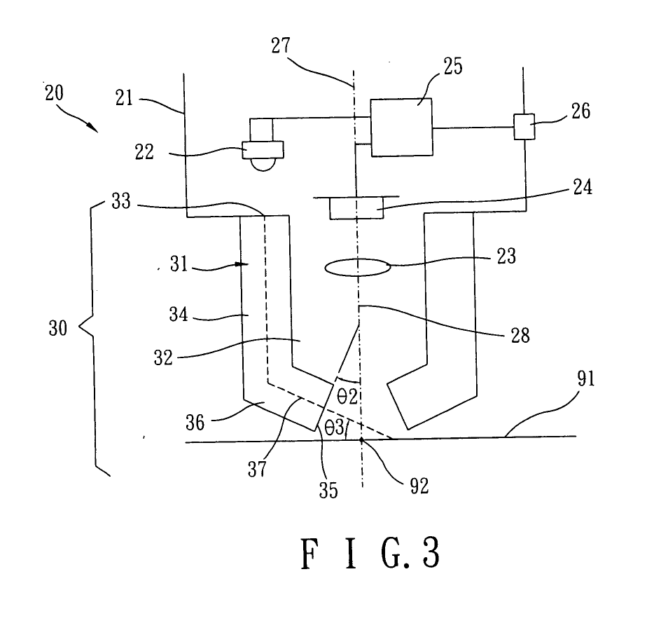

Referring to FIG. 3 which shows a schematic view of the second preferred embodiment of a light guiding apparatus 30 of optical pen 20, the optical pen 20 according to the invention similarly comprises a shaft 21, a light source 22, a lens 23, an optical sensor 24, a control unit 25, a button 26, and a light guiding apparatus 30. In this embodiment, the light guiding apparatus 30 similarly consists of a light guide 31, which is also situated at the end (bottom) of shaft 21 to constitute the tip part of optical pen 20.

The shaft 21 constitutes the body of optical pen 20 to accommodate its parts. In this embodiment, shaft 21 is in long and narrow rod shape extending a predetermined length along axial direction 27. Thus in this embodiment, the tip of optical pen 20 (constituted by optical guide 31) and shaft 21 have the same axial direction 27.

The light source 22 produces light to shine on a predetermined location 92 on an outlying surface 91 near the end (bottom) of shaft 21 to obtain reflected imaging light, which travels in a direction defined with a captured light 28. The direction of captured light 28 overlaps with axial direction 27.

The lens 23 is disposed anterior to optical sensor 24, which may be a single lens or a lens set to converge imaging light and form images on optical sensor 24.

Optical sensor 24 is for detecting imaging light from predetermined location 92 and converting it into an electric signal. In this embodiment, the optical sensor 24 is located on axial direction 27.

The control unit 25 is connected to light source 22 and optical sensor 24 to receive electrical signal from optical sensor 74 and process the signal to generate a corresponding first control signal. The button 26 is connected to the control unit 25. By pressing the button 26, the control unit 75 can produce a corresponding second control signal.

As shown in FIG. 3, the light guide 31 of the present invention is situated at the end (bottom) of shaft 21 to constitute a tip construction co-axial with shaft 21. Moreover, light guide 31 has a hollow, annular column construction disposed with a through-hole 32 along the extension of captured light direction for the reflected imaging light to pass through. The light guide 31 comprises a light-inlet 33, an extension member 34 and a light-outlet 35. The light-inlet 33 is adjacent to light source 22. The extension member 34 extends a predefined distance from the light-inlet 33 essentially along a direction opposite to the direction of captured light 28. The light-outlet 35 is situated at the end of extension member 34 away from light-inlet 33 and adjacent to the predetermined location 92 on outlying surface 91. After light emitted from light source 22, the light enters the light guide 31 at a predefined angle through the light-inlet 33, it undergoes total internal reflection inside the light guide 31 once or several times, and is then guided by light guide 31 to exit from light-outlet 35.

In the second embodiment, a portion of the extension member 34 of light guide 31 at the place close to the light-outlet 35 is further disposed with a bend member 36 that bends towards the direction of captured light 28. In addition, the light-outlet 35 of the light guide 31 is a beveled plane (but can also be an arc or spherical surface), and the intersection angle θ2 between light-outlet 35 and the direction of captured light 92 ranges between 21˜50 degrees. That is, when the optical pen 20 contacts the outlying surface 91 nearly vertically, the angle θ3 intersecting the direction of light exit 37 defined by a direction perpendicular to the light-outlet 35 and the outlying surface 91 will be in principle equal to θ2, that is, between 21˜50 degrees. When θ2 or θ3 ranges between 21˜50 degrees, the contrast ratio of imaging light reflected by outlying surface 91 will increase significantly in comparison with prior art as shown in FIG. 1. Consequently, the quality and recognizability of images detected by the optical sensor 24 of optical pen 20 would also rise substantially.

In addition, the intersection angle θ2 between light-outlet 35 of the light guiding apparatus 30 of optical pen 20 and the direction of captured light 28 is preferably between 25 and 40 degrees. In that range, not only better quality and recognizability of reflected images can be obtained, the intersection angle θ3 between light-outlet 37 and outlying surface 91 will stay below 55 degrees even if the user holds and operates optical pen 20 at an inclined angle (approximately between 5 to 15 degrees), which also results in good quality and recognizability of reflected images.

The other preferred embodiments described below have identical or similar elements to those described earlier. Those elements are assigned the same numeral (with only a English letter suffix for distinction purpose) and names and their detailed constitutions will not be elaborated.

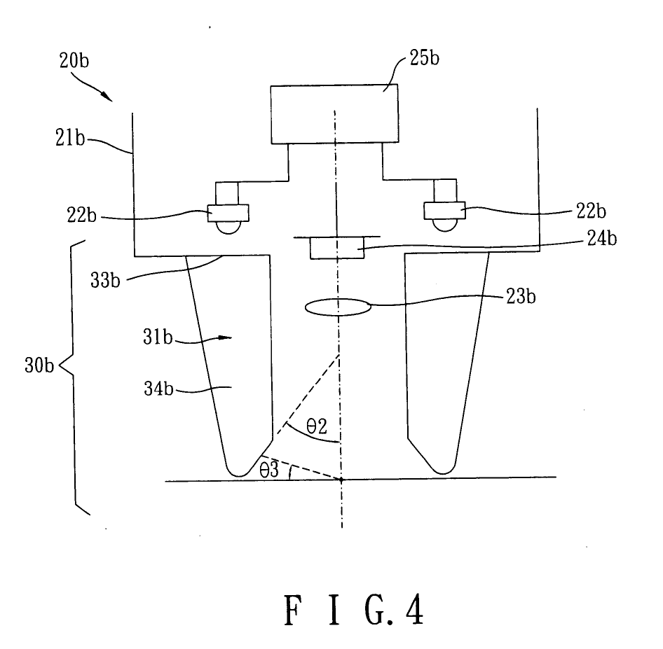

FIG. 4 shows the schematic view of the third preferred embodiment of a light guiding apparatus 30b of optical pen 20b. The optical pen 20b according to the invention similarly comprises a shaft 21b, a light source 22b, a lens 23b, an optical sensor 24b, a control unit 25b, and a light guiding apparatus 30b (light guide 31b). Its dissimilarities with other embodiments are as follows:

The area of a cross section of the extension member 34b of light guide 31b tapers gradually in a direction from the light-inlet 33b towards the light-outlet 35b to give light guide the construction of gradually tapered circular cone. In addition, two or more light sources 22b are disposed on the light-inlet 33b of light guide 34b to increase luminosity. In FIG. 4, angle θ3 similarly lies between 21˜50 degrees.

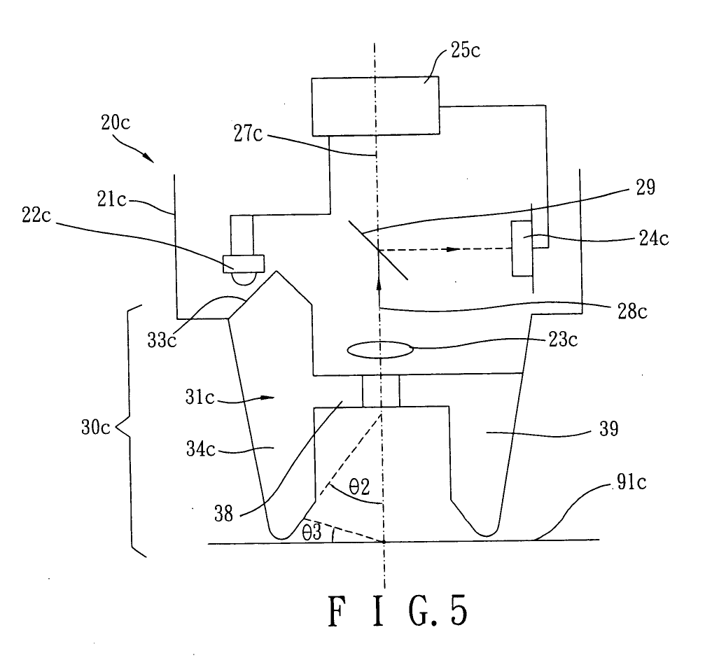

FIG. 5 shows the schematic view of the fourth preferred embodiment of a light guiding apparatus 30c of optical pen 20c. The optical pen 20c according to the invention similarly comprises a shaft 21c, a light source 22c, a lens 23c, an optical sensor 24c, a control unit 25c, and a light guiding apparatus 30c (including light guide 31c). Its dissimilarities with other embodiments are as follows:

The light-inlet 33c of light guide 31c is widened and enlarged to facilitate the entering of rays from light source 22c into light guide 31c. In addition, the middle section of extension member 34c is arranged with a light guiding bridge structure 38 to let part of the rays in light guide 31c shine on another area of extension member 39 farther away from light source 22c through the bridge 38 so the outlying surface 91c is more uniformly illuminated. The interior of light open 20c is further arranged with a reflector 29 to change the direction of captured light 28c so that optical sensor 24c is not necessarily configured on axial direction 27c. In FIG. 5, angle θ3 similarly ranges between 21˜50 degrees.

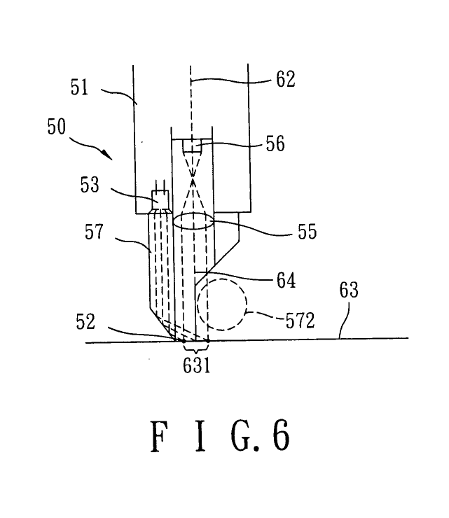

FIG. 6 shows the schematic view of the fifth preferred embodiment of a light guiding apparatus of optical pen 50. The optical pen 50 according to the invention similarly comprises a shaft 51, a tip 52, a light source 53, a lens 55, an optical sensor 56, and a light guide 57. Its dissimilarities with other embodiments are as follows:

The top end of light guide 57 is adjacent to light source 53, while the other end is close to tip 52 and is disposed with an oblique conical surface 571. A reflective plane may be formed on the oblique conical surface 571 by, for example, coating a layer of reflective material on its outer surface or simply setting a proper angle so that light inside light guide 57 may be reflected by the oblique conical surface 571 and change direction. Through the arrangement of the oblique conical surface 571, light rays produced by light source 53 may be guided and converge at an inclined angle of 21˜50 degrees towards a predetermined location 631 on outlying surface 63 nearby the tip 52. Also, the path of the reflected imaging light 64 is coaxial with the axial direction 62 of shaft 51 (i.e. overlapping).

In addition, the portion of light guide 57 (at the lower right section of light guide 57 as shown in FIG. 6) farther away from the light source 53 and closer to the predetermined location 631 is disposed with an excised part 572 to give light guide 57 a shape similar to the nib construction of regular fountain pen. Consequently, a relatively sharper tip 52 can facilitate writing.

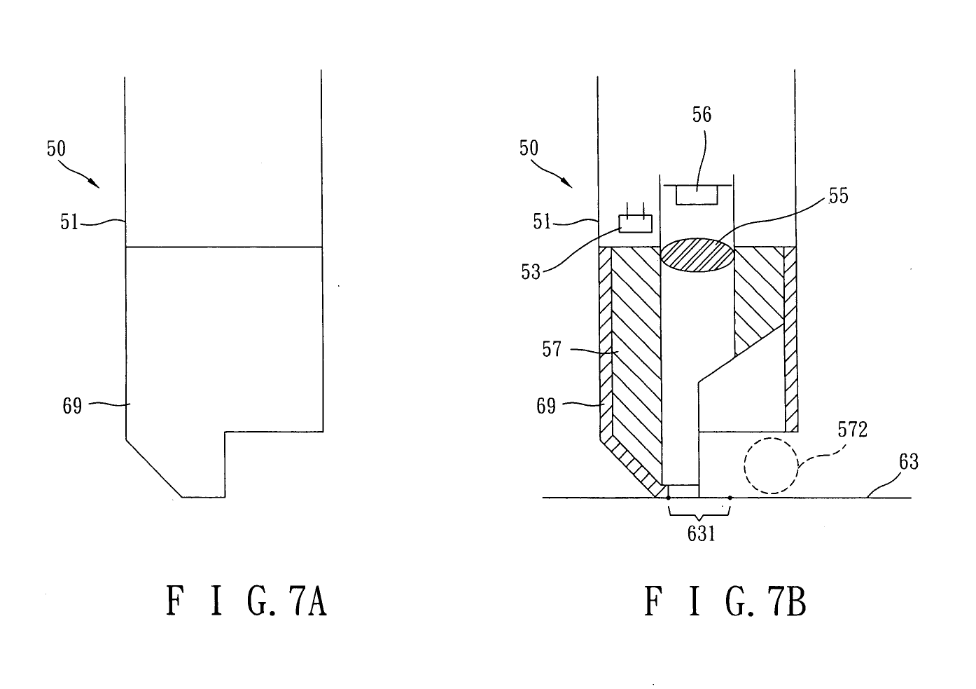

FIG. 7A and FIG. 7B are respectively a perspective view and cross-sectional view of the sixth preferred embodiment of light guiding apparatus of optical pen 50 according to the invention. In this embodiment, the optical pen 50 similarly comprises a shaft 51, a tip 52, a light source 53, a lens 55, an optical sensor 56, and a light guide 57. Its dissimilarities with other embodiments are as follows:

The exterior of light guide 57 is further disposed with a wear-resistant cap 69 to protect the tip 52. Given light guide 57 is made of transparent plastic material, its tip 52 at the very end is prone to wear after prolonged friction with outlying surface 63. So in this embodiment, a wear-resistant cap 69 is disposed on light guide 57, and the excised part 572 near the tip 52 is similarly excised to obtain an opening that allows rays to reach a predetermined location 631 on the outlying surface 63 nearby the tip 52 at a low angle of 21˜50 degrees.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. A light guiding apparatus of optical pen, said optical pen comprising a light source and an optical sensor, the light source emitting light to shine on a predetermined location of an outlying surface, and the optical sensor capturing a reflected imaging light from said predetermined location; the light guiding apparatus comprising:
a light guide made of light conducting material and consisting of a light-inlet and a light-outlet, the light-inlet being adjacent to the light source, the light-outlet being adjacent to the predetermined location, the light rays emitted from light source entering the light guide through the light-inlet and exiting from the light-outlet.

2. The light guiding apparatus of optical pen according to claim 1, wherein a light-outlet direction for light rays emitted from the light-outlet is defined, and the angle intersecting said direction and the outlying surface ranges between 21 and 50 degrees.

3. The light guiding apparatus of optical pen according to claim 1, wherein a light-outlet direction for light rays emitted from the light-outlet is defined, and the angle intersecting said direction and the outlying surface ranges between 25 and 40 degrees.

4. The light guiding apparatus of optical pen according to claim 1, wherein the light conducting material of light guide has a predetermined refraction coefficient so that light entering the light guide at a predefined angle through the light-inlet would undergo total internal reflection inside the light guide at least once before it is guided by the light guide to exit from light-outlet.

5. The light guiding apparatus of optical pen according to claim 4, wherein the light guide has a solid, long and narrow cone-column construction and is further disposed with a reflective plane of predefined angle at the side of light guide opposing the light-outlet; the reflective plane of predefined angle causes light rays inside light guide to undergo total reflection, change direction towards the light-outlet, and exit therefrom out of light guide.

6. The light guiding apparatus of optical pen according to claim 5, wherein the light-inlet has a convex structure to converge light rays from light source such that the light from light source that enters the light guide through light-inlet would essentially travel parallel along the extension direction of light guide.

7. The light guiding apparatus of optical pen according to claim 5, wherein the area of a cross section of light guide tapers gradually from the light-inlet towards the light-outlet.

8. The light guiding apparatus of optical pen according to claim 4, wherein the light-inlet of light guide is designed with a widened and enlarged structure to facilitate the entering of rays from light source into light guide, and the middle section of light guide is further arranged with a light guiding bridge structure to let part of the rays in light guide shine on another area of extension member farther away from the light source.

9. The light guiding apparatus of optical pen according to claim 4, wherein the optical pen further includes a shaft in long and narrow rod shape extending a predetermined length along the axial direction, and the light guide is situated at one end of the shaft to constitute a tip construction co-axial with the shaft; moreover, the light guide has a hollow, annular column construction disposed with a through-hole along the extension of captured light direction for the reflected imaging light to pass through.

10. The light guiding apparatus of optical pen according to claim 1, wherein the optical pen further comprises:
a control unit connected to the light source and the optical sensor to receive electrical signal from optical sensor and process the signal to generate a corresponding first control signal;
a button connected to the control unit, where the control unit can produce a corresponding second control signal when the button is pressed;
an elastic member linked to the light guide, which provides a recoil force that allows the light guide to produce compressive micro-displacement;
a pressure sensor connected to the elastic member for detecting the pressure change of elastic member and generating a corresponding third control signal; and
a lens disposed anterior to optical sensor, which causes reflected imaging light to form images on the optical sensor.

11. The light guiding apparatus of optical pen according to claim 1, wherein the portion of light guide farther away from the light source is disposed with an excised part to give the shape of light guide similar to the nib construction of regular fountain pen.

12. The light guiding apparatus of optical pen according to claim 1, wherein the exterior of light guide is further disposed with a wear-resistant cap to protect the end of light guide and said wear-resistant cap is configured with an opening at a position corresponding to the light-outlet of light guide.

13. A light guiding apparatus of optical pen, said optical pen comprising a light source and an optical sensor, the light source emitting light to shine on a predetermined location of an outlying surface, and the optical sensor capturing a reflected imaging light from said predetermined location, and the reflected imaging light traveling in a direction defined with a captured light; the light guiding apparatus comprising:
a light guide made of light conducting material and consisting of a light-inlet and a light-outlet, the light-inlet being adjacent to the light source, the light-outlet being adjacent to the predetermined location, the light rays emitted from light source entering the light guide through the light-inlet and exiting from the light-outlet;
wherein the angle intersecting the light rays emitted from the light-outlet and the outlying surface ranges between 21 and 50 degrees.

14. The light guiding apparatus of optical pen according to claim 13, wherein the angle intersecting the light rays emitted from the light-outlet and the outlying surface ranges between 25 and 40 degrees.

15. The light guiding apparatus of optical pen according to claim 13, wherein the light conducting material of light guide has a predetermined refraction coefficient so that light entering the light guide at a predefined angle through the light-inlet would undergo total internal reflection inside the light guide at least once before it is guided by the light guide to exit from light-outlet; wherein, the light guide has a solid, long and narrow cone-column construction and is further disposed with a reflective plane of predefined angle at the side of light guide opposing the light-outlet; the reflective plane of predefined angle causes light rays inside light guide to undergo total reflection, change direction towards the light-outlet, and exit therefrom out of light guide.

16. The light guiding apparatus of optical pen according to claim 15, wherein the light-inlet has a convex structure to converge light rays from light source such that the light from light source that enters the light guide through light-inlet would essentially travel parallel along the extension direction of light guide; wherein the area of a cross section of light guide tapers gradually from the light-inlet towards the light-outlet; wherein the exterior of light guide is further disposed with a wear-resistant cap to protect the end of light guide and said wear-resistant cap is configured with an opening at a position corresponding to the light-outlet of light guide.

17. A light guiding apparatus of optical pen, said optical pen comprising a light source and an optical sensor, the light source emiting light, from which the optical sensor capturing a reflected imaging light, and the reflected imaging light traveling in a direction defined with a captured light; the light guiding apparatus comprising:
a light guide made of light conducting material and consisting of a light-inlet, a reflective plane and a light-outlet, the light-inlet being adjacent to the light source, the reflective plane and the light-outlet being situated at one end of light guide farther away from the light-inlet and opposite each other, the light rays emitted from light source entering the light guide through the light-inlet and exiting from the light-outlet after reflection by the reflected plane;
wherein the reflective plane is arranged at such an angle that after the light emitted from light source enters the light guide through the light-inlet, it shines on the reflective plane at a relatively smaller angle, and is thereby totally reflected by the reflective plane and shoots at the light-outlet at a relatively larger angle, such that the light exits the light guide from the light-outlet.

18. The light guiding apparatus of optical pen according to claim 17, wherein a light-outlet direction for light rays emitted from the light-outlet is defined, and the angle intersecting the light rays emitted from the light-outlet and the outlying surface ranges between 21 and 50 degrees.

19. The light guiding apparatus of optical pen according to claim 17, wherein the light conducting material of light guide has a predetermined refraction coefficient so that light entering the light guide at a predefined angle through the light-inlet would undergo total internal reflection inside the light guide at least once before it is guided by the light guide to exit from light-outlet; wherein, the light guide has a solid, long and narrow cone-column construction and is further disposed with a reflective plane of predefined angle at the side of light guide opposing the light-outlet; the reflective plane of predefined angle causes light rays inside light guide to undergo total reflection, change direction towards the light-outlet, and exit therefrom out of light guide.

20. The light guiding apparatus of optical pen according to claim 19, wherein the light-inlet has a convex structure to converge light rays from light source such that the light from light source that enters the light guide through light-inlet would essentially travel parallel along the extension direction of light guide; wherein the area of a cross section of light guide tapers gradually from the light-inlet towards the light-outlet; wherein the exterior of light guide is further disposed with a wear-resistant cap to protect the end of light guide and said wear-resistant cap is configured with an opening at a position corresponding to the light-outlet of light guide.
